(19) United States
(12) Patent Application Publication
(10) Pub. No.: US 2022/0040532 A1
(43) Pub. Date: Feb. 10, 2022

(54) UTILIZING MACHINE LEARNING AND COGNITIVE STATE ANALYSIS TO TRACK USER PERFORMANCE

(71) Applicant: Accenture Global Solutions Limited, Dublin (IE)

(72) Inventors: Giovanna FERRARI, Newcastle upon Tyne (GB); Charlie Hendrik WIJSMAN, Penn (GB); Thomas WHITE, Carshalton (GB); Ebtihal OKOK, Newcastle Upon Tyne (GB); Stephen SMITH, Tyne and Wear (GB); Danielle POTTS, Sunderland (GB); Lucas PARISI, North Shields (GB); Zohaib TESNEEM, Newcastle upon Tyne (GB); Simon O'DONOGHUE, Southport (GB); Paul MCMURRAY, Tyne and Wear (GB)

(21) Appl. No.: 17/394,639

(22) Filed: Aug. 5, 2021

Related U.S. Application Data
(60) Provisional application No. 63/063,533, filed on Aug. 10, 2020.

(51) Int. Cl. A63B 24/00; G06N 20/00; A63B 71/06

(52) U.S. Cl. CPC A63B 24/0062; G06N 20/00; A63B 2220/836; A63B 24/0075; A63B 71/0622

(57) ABSTRACT

In some implementations, a device may receive performance data associated with a performance of a user during an activity session. The device may receive, from a user device, media data associated with the user being involved in the activity session. The device may process, using a cognitive state analysis model, the media data to determine a cognitive state score associated with a cognitive state of the user in relation to the activity session. The device may process, using a performance analysis model, the cognitive state score and the performance data to generate a performance profile for the user. The device may determine, based on the performance profile, a recommendation associated with an activity performed during the activity session. The device may perform, based on the performance profile, an action associated with the recommendation.

### CROSS-REFERENCE TO RELATED APPLICATION

This patent application claims priority to U.S. Patent Application No. 63/063,533, filed on Aug. 10, 2020, and entitled “UTILIZING MACHINE LEARNING AND COGNITIVE STATE ANALYSIS TO TRACK USER PERFORMANCE.” The disclosure of the prior application is considered part of and is incorporated by reference into this patent application.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial analyses, medical diagnosis, and/or information retrieval, among many other examples.

### SUMMARY

Some implementations described herein relate to a method. The method may include receiving performance data associated with a performance of a user during an activity session. The method may include receiving, from a user device, media data associated with the user being involved in the activity session. The method may include processing, using a cognitive state analysis model, the media data to determine a cognitive state score associated with a cognitive state of the user in relation to the activity session. The method may include processing, using a performance analysis model, the cognitive state score and the performance data to generate a performance profile for the user, where the performance analysis model comprises a machine learning model that is trained based on historical performance data and historical cognitive state scores associated with corresponding historical activities performed during historical activity sessions. The method may include determining, based on the performance profile, a recommendation associated with an activity performed during the activity session. The method may include performing, based on the performance profile, an action associated with the recommendation.

Some implementations described herein relate to a device. The device may include one or more memories and one or more processors coupled to the one or more memories. The one or more processors may be configured to receive performance data associated with a performance of an activity by a user. The one or more processors may be configured to receive media data associated with the user being involved in the activity. The one or more processors may be configured to process, using a cognitive state analysis model, the media data to determine a cognitive state score associated with the user in relation to the activity. The one or more processors may be configured to process, using a performance analysis model, the cognitive state score and the performance data to generate a performance profile for the user. The one or more processors may be configured to provide information from the performance profile that is associated with the user performing the activity in association with the cognitive state.

Some implementations described herein relate to a non-transitory computer-readable medium that stores a set of instructions for a device. The set of instructions, when executed by one or more processors of the device, may cause the device to receive media data associated with a performance of an activity by a user. The set of instructions, when executed by one or more processors of the device, may cause the device to determine, based on a sentiment analysis of the user as conveyed in the media data, a cognitive state score associated with the user performing the activity. The set of instructions, when executed by one or more processors of the device, may cause the device to determine, based on performance data associated with the user performing the activity, a performance score associated with the performance. The set of instructions, when executed by one or more processors of the device, may cause the device to generate, using a performance analysis model, the cognitive state score, and the performance score, a performance profile associated with the user and the activity. The set of instructions, when executed by one or more processors of the device, may cause the device to perform, based on the performance profile, an action associated with the user and the performance profile to indicate a relationship between the activity and a cognitive state of the user.

### BRIEF DESCRIPTION OF THE DRAWINGS

FIG. 1 is a diagram of an example implementation described herein.

FIG. 2 is a diagram associated with an example implementation of a machine learning model described herein.

FIG. 3 is a diagram associated with an example implementation of another machine learning model described herein.

FIGS. 4A-4B are diagrams of an example implementation described herein.

FIG. 5 is a diagram of an example environment in which systems and/or methods described herein may be implemented.

FIG. 6 is a diagram of example components of one or more devices of FIG. 5.

FIG. 7 is a flowchart of an example process relating to utilizing machine learning and cognitive state analysis to track user performance.

### DETAILED DESCRIPTION

The following detailed description of example implementations refers to the accompanying drawings. The same reference numbers in different drawings may identify the same or similar elements.

In many instances, tracking performance of a user involves examining and/or recording the user's ability to perform an activity and/or engage in an activity session (e.g., fitness training event, a sports game, or other type of sessions involving physical activity). The activity may involve an exercise or type of sports-based activity. For example, such tracking typically involves measuring the performance using one or more sensors and/or results of the activity (e.g., whether the activity could be performed and/or how effectively the activity was performed). However, certain characteristics of a tracked user (e.g., a subject of a performance analysis) when performing an activity during an activity session (e.g., a competition involving the user, a fitness session involving various exercises, actions of tasks associated with employment of the user, and/or the like) can contribute to the performance by the user. For example, such characteristics may correspond to a cognitive state (e.g., a sentiment or an emotion) of the user relative to when the user performs the activity (e.g., before, during, and/or after performance of the activity), a cognitive state of the user relative to the activity or an activity session that includes the activity, a cognitive state of the user relative to other users associated with the activity session (e.g., competitors, clients, associates, and/or the like), a cognitive state of the user relative to an amount of the activity being performed or a duration of an activity session, a cognitive state of the user relative to a manner of performing the activity, and so on.

However, tracking such characteristics to analyze a performance of a user may involve a user or a manager (e.g., a coach, therapist, trainer, employer, teacher, and/or the like) associated with the user personally tracking such characteristics with respect to a performance of an activity. In such a case, the user may choose to only perform certain activities that the user prefers, thereby reducing an opportunity for the user to improve certain skills that are trained by certain activities (e.g., by repeating certain activities) that are avoided by the user. Furthermore, the manager may inaccurately judge certain cognitive states of the user (e.g., based on whether the user is accurately (or honestly) offering or showing certain sentiment or emotions associated with a particular activity). Accordingly, there is a need for a system that accurately measures a performance of an activity or an activity session in association with one or more cognitive states of a user in order to determine a performance profile of the user and/or improve a performance of an activity, by the user, regardless of a cognitive state of the user and/or under certain cognitive states.

According to some implementations, a performance analysis system is provided that utilizes one or more machine learning models and a cognitive state analysis, to monitor, analyze, track, and/or provide recommendations to improve user performance of an activity. For example, the performance analysis system may use a performance analysis model that may be associated with one or more machine learning models. The performance analysis model may be trained and/or configured to determine optimal conditions and/or optimal parameters for activities that may facilitate an optimal performance of the activities and/or an optimal participation in an activity session by the user. In such an example, the optimal conditions and/or optimal parameters may be determined and/or provided by the performance analysis model based on a cognitive state of the user relative to performance of certain activities and/or relative to performance during certain events involving the activities.

As described herein, the performance analysis system may identify a user's ability to perform the activity with a particular cognitive state, determine a user's effort with respect to performing the activity with the particular cognitive state, determine a level of success associated with performing the activity with the particular cognitive state, and/or the like. The performance analysis system may obtain performance data associated with performing an activity or participating in an event using sensor readings from one or more sensors of a user device of the user and/or a performance monitoring device associated with the user (e.g., a wearable device or other type of device that monitors user activity via a performance sensor).

The performance analysis system may track and/or maintain such activity information (e.g., cognitive states and/or performance data associated with activities) in a data structure (e.g., a user-specific database) to permit a machine learning model to learn which activities of an activity session, which durations of activities of the activity session, and/or which other parameters of activities and/or activity sessions provide an optimal performance of the user and/or contribute to optimal cognitive states for performing the activities. In this way, the system can determine and/or suggest recommendations to the user and/or a manager of the user for performing an activity of an activity session, participating in an activity, training for an activity, and so on. While some examples are described herein in connection with an activity, such examples may similarly apply to an activity session that involves the particular activity and/or multiple activities.

In some implementations, the performance analysis system may utilize a flexible architecture (e.g., a cloud computing environment) to permit dynamic alteration and integration of artificial intelligence and/or machine learning components to permit tracking and analysis of a user performance based on a cognitive state of the user. For example, the performance analysis system may utilize an application installed on a user device that is capable of obtaining performance data associated with measuring a performance of an activity by a user. For example, the application may be used to obtain media data from the user that may be used to determine a cognitive state of the user relative to performing the activity. The performance analysis system may serve as a backend system for processing the performance data and/or media data to track the user performance relative to a cognitive state of the user, as described herein. In this way, relative to other performance tracking systems, the performance analysis system reduces utilization of computing resources, based on faster and more accurate detection of user cognitive state, faster and more accurate measurement of user performance (e.g., less resources may be needed to determine a map of user cognitive state to user performance, identify trends between user cognitive state and user performance, and/or the like), and/or improves scalability of user performance management (e.g., multiple dedicated models can be configured and trained for individual users that are tracked using the performance analysis system), among other examples.

By reducing the utilization of computing resources via an application as described herein, the performance analysis system improves overall system performance and accuracy due to efficient and effective allocation of resources for receiving media data that is processed to determine a cognitive state of a user (e.g., receiving media data, such as audio recordings, video recordings, text inputs, and/or the like), receiving performance data from wearable devices and/or applications configured to monitor performance of an activity, processing the media data to determine the cognitive state, processing the performance data to determine a quality of the performance, mapping the media data and the performance data, identifying trends between certain cognitive states of the user and performances by the user, training and/or retraining a machine learning model to identify the trends, and/or the like. Furthermore, faster and/or more accurate trend detection between user cognitive state and user performance improves user experience and minimizes time lost due to the user engaging in undesirable activities and/or due to the user engaging in ineffective activities.

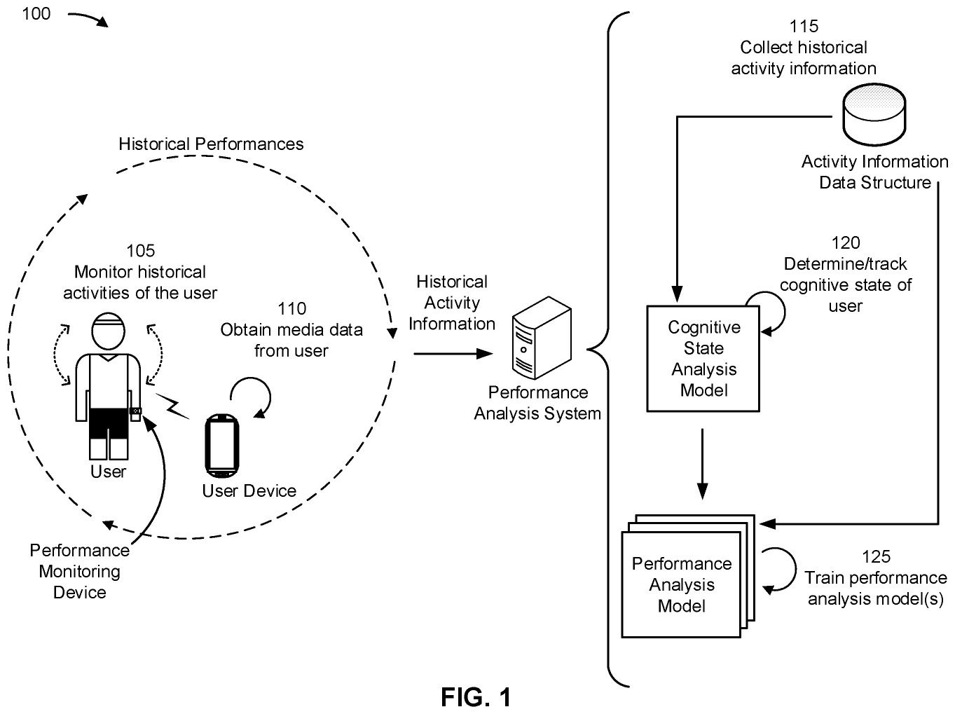

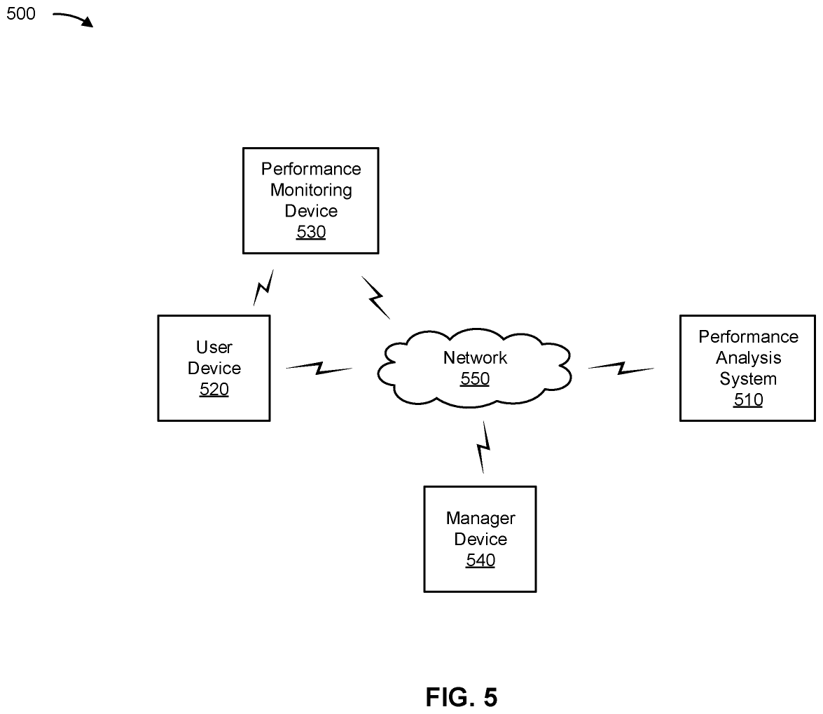

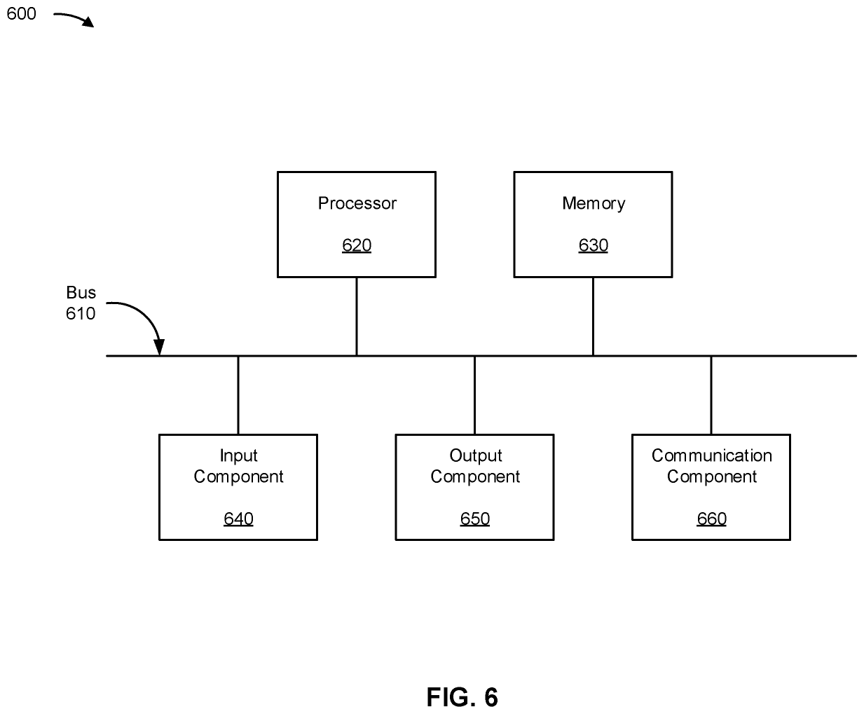

FIG. 1 is a diagram of an example implementation 100 associated with utilizing machine learning and cognitive state analysis to track user performance. As shown in FIG. 1, example implementation 100 includes a performance analysis system, a user device, and a performance monitoring device. The user device and/or the performance monitoring device may be associated with a user and/or configured to measure performances of historical activities by the user or other users, as described herein. The performance analysis system may include an activity information data structure, a cognitive state analysis model, and one or more performance analysis models. In example implementation 100, the performance analysis system is configured to utilize the cognitive state analysis model and/or performance data to train one or more performance analysis models described herein. These devices are described below in connection with FIG. 5 and FIG. 6.

As shown in FIG. 1, and by reference number 105, the performance monitoring device and/or the user device may monitor historical activities of the user. For example, an application associated with the user device and/or the performance monitoring device may obtain historical performance data associated with the user performing the historical activities. The historical performance data may include and/or may be associated with measurements from one or more performance sensors (e.g., one or more accelerometers, one or more vitals sensors, one or more power or strength sensors, one or more speed sensors, and so on) that are associated with measuring performance parameters (e.g., speed, efficiency, accuracy, timing, power output, heart rate, and so on) that are monitored during the user's performances of the historical activities.

In some implementations, the performance monitoring device may be a wearable device that is configured to measure performance parameters associated with the user performing the historical activities. Additionally, or alternatively, the performance monitoring device may be associated with a machine or system (e.g., an exercise machine, a skills training machine, or other type of activity-based machine) that measures the performance parameters. The user device and/or the performance monitoring device, as described herein, may include an application for monitoring the user. Correspondingly, the user device and/or the performance monitoring device may communicate with one another, via the application, in order to obtain and/or generate the performance data associated with the user performing historical activities. In some implementations, the performance data includes calendar information (e.g., a date, a time, and/or a duration) associated with a historical activity and/or a historical activity session.

As further shown in FIG. 1, and by reference number 110, the user device obtains media data associated with the user. For example, the media data may include or be associated with audio/video media with content that is associated with the user performing the historical activities. In some implementations, the media data may include a user input (e.g., an input to an application) associated with the user performing the historical activities. For example, the user input may indicate or specify a cognitive state of the user in association with the user performing the historical activities. The media data may be associated with the user performing the activity and/or engaging in an activity session based on timing associated with the media data. For example, the media data may be captured during a certain time period that is before, during, or after the activity and/or activity session. Accordingly, the media data may include content (e.g., audio, video, and/or text) that depicts or conveys the user preparing for, conducting, and/or thinking about (e.g., reflecting on, contemplating, visualizing, and so on) a particular activity and/or activity session.

As further shown in FIG. 1, and by reference number 115, the performance analysis system collects historical activity information from the user device. For example, the performance analysis system may collect the performance data and/or the media data from the user device and/or the performance monitoring device. In some implementations, the performance analysis system may collect the historical activity information via the application described above. The performance analysis system may collect the historical activity information based on individual historical activities being performed by the user. Additionally, or alternatively, the performance analysis system may receive the historical activity information in a batch format that includes historical activity information associated with a plurality of historical activities. The historical activity information may be associated with a particular type of activity and/or a particular type of activity session.

The activity information data structure may include any suitable data structure (e.g., a database, a table, a list, a task graph, and/or the like) associated with the performance analysis system. In some implementations, the activity information data structure may include thousands, millions, billions, etc. of data points associated with prior activities performed by one or more users (and/or user accounts associated with the application). The performance analysis system may preprocess the historical activity information in association with storing and/or maintaining the historical activity information in the activity information data structure. For example, the historical activity information may sort the performance data and/or media data according to a date and/or time of an activity or a type of an activity session, a type of an activity or a type of an activity session, a user associated with an activity, a type of performance parameter that was measured or monitored during an activity, and/or an associate of one or more users performing an activity or engaging in an activity session. Accordingly, the performance analysis system may store and/or maintain the historical activity information using a preprocessing technique that sorts and/or clusters the historical activity information in any suitable manner.

As further shown in FIG. 1, and by reference number 120, the performance analysis system determines and/or tracks the cognitive state of the user. For example, the performance analysis system, via the cognitive state analysis model, may determine cognitive state scores that are associated with cognitive states of the user in association with the user performing the historical activities. The cognitive state analysis model may determine the cognitive state scores based on the media data. In some implementations, the cognitive state analysis model may include and/or utilize one or more speech processing techniques, such as a speech recognition and/or a speech-to-text (STT) technique, among other examples. Additionally, or alternatively, the cognitive state analysis model may utilize natural language processing and/or a sentiment analysis technique to determine a cognitive state of the user from audio, video, and/or text that conveys the user's respective cognitive states when performing the historical activities and/or the user's respective cognitive states that are associated with the user performing the historical activities (e.g., respective sentiments toward the historical activities after performing the historical activities). In this way, the performance analysis system may determine, monitor, and/or track a user's cognitive state in association with performance of historical activities to permit the performance analysis system to train one or more performance analysis models, as described elsewhere herein.

As further shown in FIG. 1, and by reference number 125, the performance analysis system may train the one or more performance analysis models. For example, the historical activity information (e.g., the performance data, the media data, and/or the cognitive state scores) may be used as training data, testing data, and/or evaluation data to train the one or more performance analysis models, as described elsewhere herein. A performance analysis model, as described herein, may include and/or utilize one or more of a k-fold cross validation processing, a random-forest-based classification processing, an optimization technique, support vector regression, a linear regression, and/or a neural network, among other examples. Accordingly, the performance analysis model may be trained according to the type of the performance analysis model and/or a technique used to configure the performance analysis model.

The performance analysis model may be trained (e.g., by the performance analysis system and/or by one or more other platforms associated with the performance analysis system) using historical performance data that is associated with tracking user performance based on historical cognitive states for one or more performance analysis parameters. A performance analysis parameter may include a cognitive state score (e.g., a score that is representative of a certain emotion or a certain sentiment of a user) associated with a cognitive state of the user when performing an activity or participating in an activity session, a measurement of one or more performance parameters associated with the user performing the activity or participating in the activity session, timing associated with the user performing the activity within the activity session and/or engaging in other activity sessions, a type of the activity, a type of the activity session that includes the activity, and so on. Using the historical performance data and values for the one or more performance analysis parameters as inputs to the performance analysis model, the performance analysis system may identify trends between a user cognitive state and a user performance, to permit the user and/or a manager of the user to identify optimal conditions and/or optimal manners (e.g., frequency, duration, and/or the like) in which certain activities should be performed by the user, as described herein.

In this way, the performance analysis system (and/or a system associated with the performance analysis system) may train and/or configure a performance analysis model to monitor a performance of an activity by a user according to a cognitive state of the user. The performance analysis system (e.g., via an application or flexible structure) may manage and/or map cognitive states of the user to one or more activities (or performances of activities) based on media data that is obtained from the user in association with the user's performance of the one or more activities.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

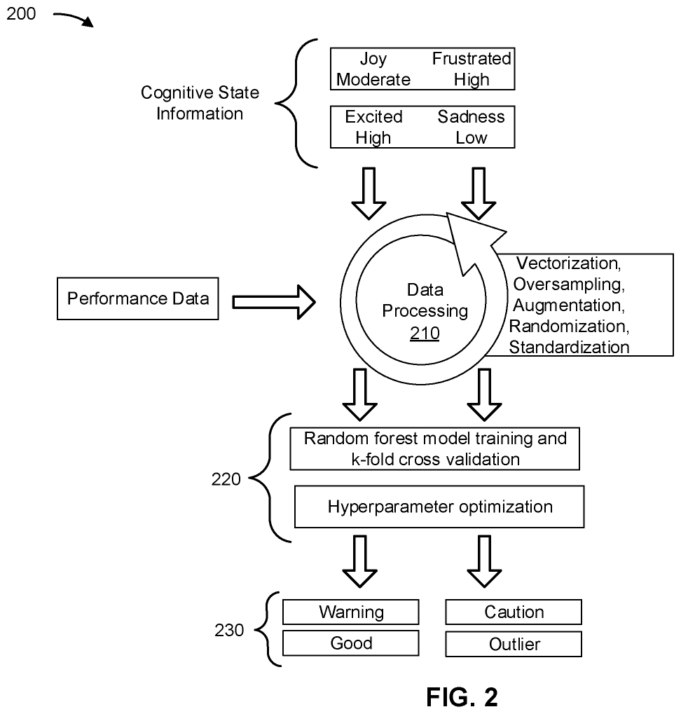

FIG. 2 is a diagram of an example implementation 200 associated with a machine learning model described herein. The machine learning model may be associated with a performance analysis model described herein. For example, example implementation 200 may be associated with a psychological impact model that is configured to attribute a psychological score or rating to an activity session (or a type of activity session) based on cognitive state information.

As shown in FIG. 2, and by reference number 210, for an activity, performance data was processed (or associated) with cognitive states (shown as “Joy,” “Frustrated,” “Excited,” and “Sadness”) and corresponding cognitive state scores for those cognitive states (“Moderate” for Joy, “High” for Frustrated, “High” for Excited, and “Low” for Sadness). The performance data and/or the cognitive states may be processed to detect trends and/or significant changes in cognitive states over time based on threshold differences in standard deviations of the cognitive states. As shown, processing the performance data may include a vectorization process (e.g., converting the performance data and/or cognitive states to vectors), an oversampling process (e.g., balancing a quantity of activities for an activity session), an augmentation process (e.g., augmenting activities and/or activity sessions that involve certain cognitive states that may be underrepresented), a randomization process (e.g., randomizing certain configurations of the performance data and/or the cognitive states as a set of inputs), and/or a standardization process (e.g., using a z-score for feature-related data so that the feature-related data is pseudo-normally distributed).

As described elsewhere herein, cognitive states and/or corresponding cognitive state scores may have been determined (e.g., from media data associated with a user that perform the activity) and/or mapped with the performance data using a cognitive state analysis model, described elsewhere herein. In some implementations, a cognitive state score may be determined based on an intensity associated with the cognitive states that was normalized (e.g., using a same scale for the cognitive states). Additionally, or alternatively, a duration (which may be normalized according to a particular frequency or time period, such as a number of days of a week having the cognitive state, a number of hours of a day having the cognitive state, and so on) to determine the cognitive state scores.

In some implementations, cognitive states and/or cognitive state scores may be identified and/or processed as pairs (e.g., based on the configuration cognitive state analysis model). For example, as shown in FIG. 2, a cognitive state analysis model associated with the machine learning model of example implementation 200 may designate Joy with Frustrated as a first pair and may designate Excited with Sadness as a second pair. Pairings of certain cognitive states may be preconfigured in any suitable manner. For example, pairs of cognitive states may be assigned and/or designated based on apparent relationships or trends between individual cognitive states of a pair of cognitive states. Additionally, or alternatively, pairs of cognitive states for a particular activity and/or activity session may be identified as most prevalent with respect to the particular activity or activity session. In some implementations, the pairs of the cognitive states may be randomized (e.g., according to the randomization technique).

As further shown in FIG. 2, and by reference number 220, the processed data may be used to train, validate, and/or optimize the machine learning model. For example, as shown, a random forest model training and k-fold cross validation may be used to train and/or validate the processed data. The random forest training may involve a random-forest-based classification processing of the performance data and/or the cognitive state scores. The a k-fold cross validation may involve a k-fold validation processing based on a resampling (e.g., for k iterations, such as 3 iterations, 5 iterations, 7 iterations or more) of the historical performance data and/or the historical cognitive state scores. The hyperparameter optimization technique may involve a random search of the processed data. For example, the hyperparameter optimization technique may involve an optimization technique for optimizing one or more random-forest hyperparameters, such as one or more hyperparameters that are based on the performance data and/or the historical cognitive state scores and/or obtained from the random-forest-based classification processing.

In some implementations, the optimization technique be configured to optimize (e.g., based on a random search associated with cross validation results of the k-fold cross validation) one or more of the following random-forest hyperparameters: a bootstrap that defines if samples are to be bootstrapped when generating trees, a class weight (whether weights associated with each class are to be balanced or defined per each class), a criterion for quantifying of a quality of a split of nodes in a tree, a maximum depth of a tree, a maximum number of features when selecting a best split, maximum number of leaf nodes that reduces or prevents impurity within a tree, a minimum quantity of samples to split an internal node in a tree, a minimum quantity of samples for (or to create) a leaf node, and/or a number of estimators/trees in a random forest of the machine learning model.

As further shown in FIG. 2, and by reference number 230, the machine learning model may provide an output that includes a recommendation associated with the activity, the activity session. For example, as shown, and based on the performance data and/or cognitive state scores, the machine learning model may indicate that performing the activity with a certain cognitive state might be detrimental (“Warning”), that a performance with a particular cognitive state is recommended (“Good”), that caution should be used when performing the activity with a certain cognitive state (“Caution”), or that a certain performance of the activity with a certain cognitive state was an anomaly (“Outlier”).

In this way, the machine learning model of example implementation 200 may be configured to predict a sentiment of the user toward the activity (or a type of activity), thereby enabling accurate detection of a psychological impact that a cognitive state of the user has on a performance of an activity, by reducing potential for erroneous classification of a cognitive state by a manager of the user and/or dishonest indication of a cognitive state to the manager.

As indicated above, FIG. 2 is provided as an example. Other examples may differ from what is described with regard to FIG. 2.

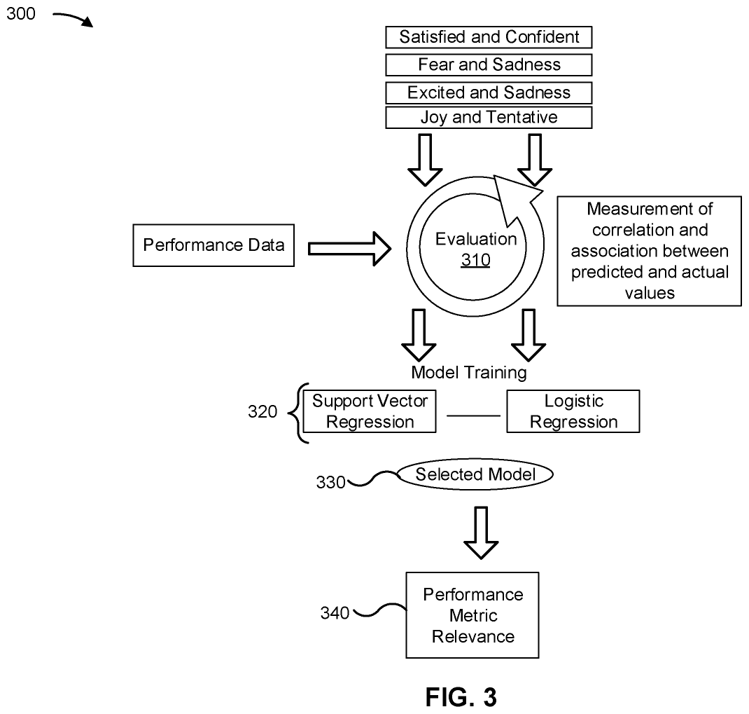

FIG. 3 is a diagram of an example implementation 300 associated with a machine learning model described herein. The machine learning model may be associated with a performance analysis model described herein. For example, example implementation 300 may be associated with a physiological impact model that is configured to provide one or more projections associated with relevant performance metrics that are based on a user's cognitive state and/or that are associated with one or more other characteristics of the user (e.g., gender, age, and/or location, among other examples).

As shown in FIG. 3, and by reference number 310, for an activity, performance data is evaluated with sets of cognitive states (shown as “Satisfied and Confident,” “Fear and Sadness,” “Excited and Sadness,” “Joy and Tentative”). For example, similar to the psychological impact model of example implementation 200, one or more sets (or pairs) of cognitive states may be analyzed and/or evaluated in association with performance data for an activity performed by a user. As shown, an evaluation of the performance data and/or the sets of cognitive states (and/or corresponding cognitive state scores) may determine a measurement of correlation and/or association between predicted and actual values for performance metrics for an activity (e.g., a future or subsequent activity) that is performed by a user with a certain set of cognitive states. The measurement of correlation and/or association may be determined according to a scoring system that is based on a support vector regression and/or a linear regression. For example, the scoring system may be configured to determine a performance metric relevance score that is indicative of an impact that a set of cognitive states have on a particular performance metric.

A performance metric, as described herein, may include any suitable performance metric that can be measured and/or monitored. For example, the performance metric may be measured and/or monitored using a user device and/or a performance monitoring device, as described elsewhere herein. Correspondingly, the machine learning model may receive measurements associated with one or more performance metrics within the performance data.

In some implementations, the performance metric may include a physiological stress metric that is associated with a subsequent performance of a subsequent activity (e.g., a subsequent activity that is a particular type of activity that is being evaluated). The physiological stress metric may be measured based on a duration and/or intensity of an activity (or activity session) to estimate an overall load and/or physiological stress experienced by a user during the activity.

The performance metric may include an activity load metric associated with a time period (e.g., a duration in days or weeks) prior to an activity session. The activity load metric may be indicative of an impact that the activity has on physical fitness of the user (or other physiological impacts on the user).

The performance metric may include an activity fatigue metric that is associated with fatigue of the user prior to the activity session. The activity fatigue metric may be associated with the physiological stress metric. For example, the activity fatigue metric may be based on measurements of the physiological stress metric during a time period that is prior to the activity. As an example, the activity fatigue metric may be based on a weighted average of measurements of the physiological stress metric during the week prior to the activity, with more weight being allocated for the physiological stress metric that is measured more recently than weight that is allocated for the physiological stress metric that is measured less recently.

The performance metric may include a power metric associated with a strength of the user during the activity session. The power metric may be indicative of a highest measure of power achieved (or measured) during an activity (and/or activity session). In some implementations, the power metric may be associated with a most recent time period (e.g., a most recent 10 minutes, a most recent 20 minutes, and so on). In some implementations, the power metric may be configured to be measured during certain types of activities (e.g., cycling, weightlifting, rowing, running, or other activities that facilitate power measurement).

The performance metric may include an intensity score associated with a relative strength of the user based on the power metric during the activity session. The intensity score may correspond to an estimate of a relative intensity as related to the user's power metric. Accordingly, the intensity metric (e.g., for a particular time period or activity) may be a percentage of the power metric and/or may be measured based on a ratio that is based on the power metric.

The performance metric may include an exertion metric that is indicative of a degree of exertion of the user during the activity session. The exertion metric may be indicative of an amount of effort put forth by the user during an activity or activity session. In some implementations, the exertion metric may be based on a weighted average of the intensity metric over a duration of the activity session.

The performance metric may include a time metric associated with timing to complete one or more activities of the activity session, and/or a total time (or volume of activities) associated with an activity session that includes an activity.

As further shown in FIG. 3, and by reference number 320, the machine learning model may be trained based on the performance data (and/or historical performance data) and/or the sets of cognitive states (and/or corresponding cognitive state scores). Accordingly, the performance analysis system may utilize, to train the machine learning model, a support vector regression involving the historical performance data and the historical cognitive state scores. Additionally, or alternatively, the performance analysis system may utilize a linear regression involving the historical performance data and the historical cognitive state scores.

As further shown in FIG. 3, and by reference number 330, based on training, according to support vector regression and the linear regression, the machine learning model using the historical performance data and/or historical cognitive state scores, for a set of performance data, the machine learning model may be configured to select the support vector regression or the linear regression as an optimal model for predicting a physiological impact according to a performance metric relevance score for an activity and/or set of cognitive scores. In this way, the machine learning model may be configured to select or utilize either support vector regression or linear regression for a particular type of performance metric. For example, the machine learning model may utilize a support vector regression to evaluate a physiological stress metric, an activity load metric, and/or an activity fatigue metric associated with an activity, and the machine learning model may utilize a linear regression to evaluate an intensity score associated with the activity.

As further shown in FIG. 3, and by reference number 340, the machine learning model, from a selected model, may determine and/or indicate a performance metric relevance based on the performance data and/or the sets of cognitive states. For example, the performance metric relevance may be provided and/or indicated as a performance metric relevance score that permits the machine learning model and/or a performance analysis system to predict a physiological impact that one or more sets of cognitive states has on a user performing an activity. Additionally, or alternatively, the performance metric relevance score may permit the machine learning model and/or the performance analysis system to predict a physiological impact that one or more sets of cognitive states have on a particular performance metric that is measured when the user performs the activity.

In this way, the machine learning model of example implementation 300 may be configured to predict a performance metric relevance score associated with a set of cognitive states of the user subsequently performing an activity during a subsequent activity session

As indicated above, FIG. 3 is provided as an example. Other examples may differ from what is described with regard to FIG. 3.

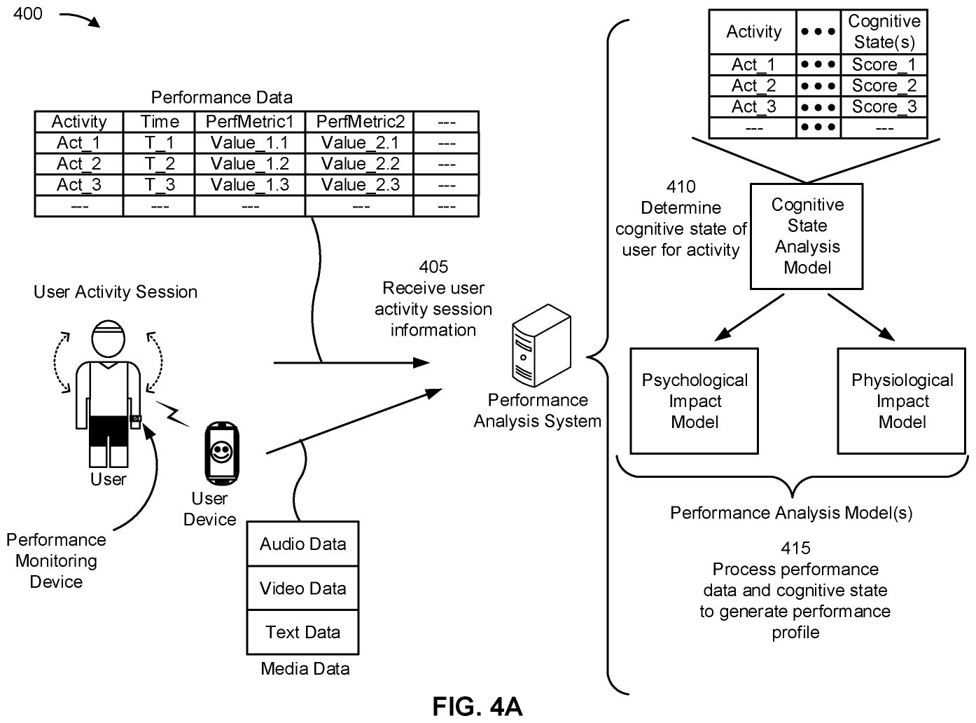

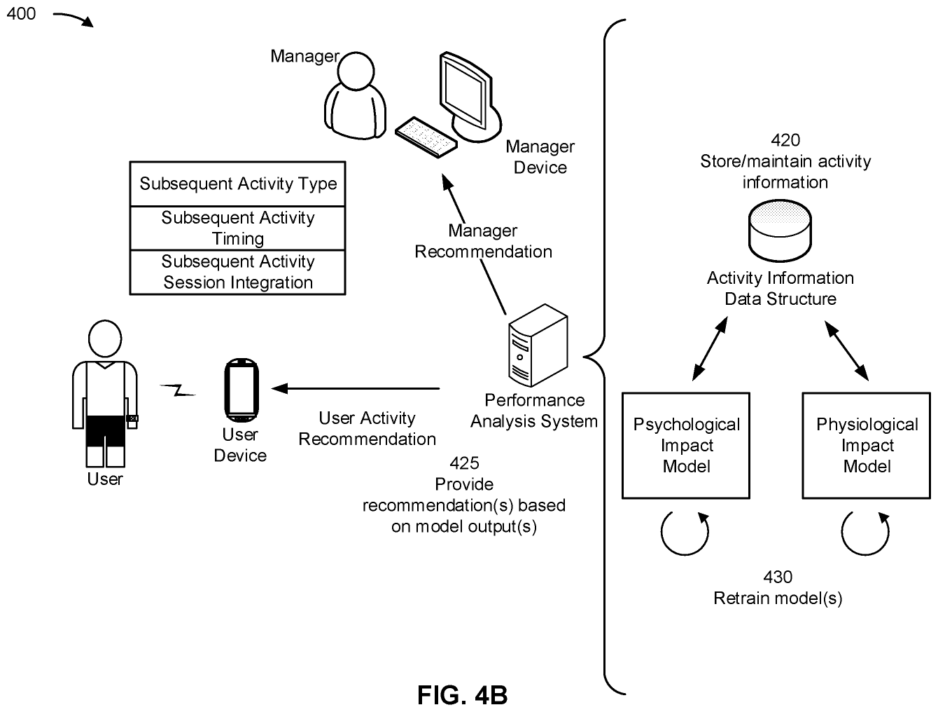

FIGS. 4A-4B are diagrams of an example implementation 400 associated with utilizing machine learning and cognitive state analysis to track user performance. As shown in FIGS. 4A and/or 4B, example implementation 400 includes a performance analysis system, a user device, a performance monitoring device, and a manager device. These devices are further described below, at least, in connection with FIG. 5 and FIG. 6.

In example implementation 400, the performance analysis system includes a psychological impact model (e.g., the machine learning model configured and/or trained according to example implementation 200) and a physiological impact model (e.g., the machine learning model configured and/or trained according to example implementation 300). The psychological impact model and the physiological impact model may be specific types of performance analysis models that are described elsewhere herein. Accordingly, the psychological impact model and/or the physiological impact model may include and/or be associated with a machine learning model that is trained based on historical performance data and historical cognitive state scores associated with corresponding historical activities performed during historical activity sessions. As described herein, the corresponding historical activities may have been performed by the user, the historical performance data may be associated with the user, and the historical cognitive state scores may be associated with one or more sentiments of the user toward the historical activities. In some implementations, the corresponding historical activities and/or historical cognitive state scores may be associated with other users that performed the corresponding historical activities and/or had respective cognitive states when performing the corresponding historical activities. The psychological impact model and physiological impact model may be referred to collectively, at least in connection with implementation 400, as “the performance analysis models.”

As shown in FIG. 4A, and by reference number 405, the performance analysis system receives user activity session information. For example, the user may perform an activity during an activity session. The activity session information may include performance data and/or activity information that identifies activities that were performed by the user during the activity session. For example, as shown in FIG. 4A, the performance data may identify activities (shown as “Act_1,” “Act_2,” and “Act_3”), time durations associated with the activities, and values for one or more performance metrics (shown as “PerfMetric1” and “PerfMetric2”) that were measured during performance of the activities. Correspondingly, the performance analysis system may receive, from the user device and/or the performance monitoring device, performance data associated with a performance of the user during the activity session. As described herein, the performance data may be captured by a performance sensor that is associated with the performance monitoring device. For example, the performance data may be received from a wearable device that is worn by a user when performing the activity and/or engaging in the activity session. In some implementations, the performance data is associated with one or more physiological metrics (e.g., strength, heart rate, breathing rate, or other physiological metrics) of the user that are measured by the performance sensor during the activity session (e.g., one or more of the performance metrics described in connection with example implementation 300).

In this way, the performance analysis system may receive performance data associated with a performance of an activity by a user.

In some implementations, the activity session information may include media data associated with the user performing an activity of the activity session. As shown, the media data may include audio data, video data, and/or text data. The media data may be associated with the user preparing for the activity session (e.g., media data conveying the user discussing an approach toward performing an activity), the user engaging in the activity session (e.g., media data conveying the user performing an activity of the activity session), and/or the user reflecting on the activity session (e.g., media data conveying the user providing feedback associated with an activity).

In this way, the performance analysis system may receive activity session information (e.g., performance data, activity information, and/or media data) that is associated with the user being involved in the activity and/or activity session.

As further shown in FIG. 4A, and by reference number 410, the performance analysis system determines the cognitive state of the user for the activity. For example, the performance analysis system may determine the cognitive state of the user via the cognitive state analysis model, as described herein. The performance analysis system may process, using a cognitive state analysis model, the media data to determine a cognitive state score associated with a cognitive state of the user in relation to the activity session.

The cognitive state score may be representative of a cognitive state of the user relative to the user being involved in the activity. Additionally, or alternatively, the cognitive state score may be representative of an emotion (e.g., happiness, sadness, anger, fear, anxiousness, nervousness, excitement, frustration, satisfaction, tentativeness, ambivalence, and so on) and/or a sentiment of the user (e.g., a sentiment toward the activity, a sentiment toward the activity session, a sentiment toward another individual involved in the activity, a sentiment toward a location of the activity, a sentiment toward a time of the activity, or sentiment toward any other element involved in an activity).

As further shown in FIG. 4A, and by reference number 415, the performance analysis system processes the performance data and the cognitive state to generate a performance profile. For example, the performance analysis system may process the performance data and cognitive state scores associated with the user performing an activity using the psychological impact model and/or the physiological impact model. Accordingly, the performance analysis system may generate the performance profile for the user to indicate whether the cognitive state of the user as indicated by the cognitive state score affected or contributed to the performance, by the user (e.g., using the psychological impact model). Additionally, or alternatively, the performance analysis system may generate the performance profile for the user to indicate a predicted performance score associated with a subsequent performance of the activity, by the user, during a subsequent activity session that involves the activity (e.g., based on a performance metric relevance score determined using the physiological impact model).

In this way, the performance analysis system may generate a performance profile of the user perform to permit the performance analysis system to perform an action based on the performance profile of the user (e.g., an action associated with a recommendation to the user, an action associated with retraining the performance analysis models. For example, based on the performance profile associated with the user (which may indicate which cognitive states may positively or negatively impact performance of certain activities), the performance analysis system may determine a recommendation for the user and/or a manager of the user.

As shown in FIG. 4B, and by reference number 420, the performance analysis system stores and/or maintains the activity information. For example, the performance analysis system may store and/or the maintain the activity information with historical performance data and/or historical cognitive state scores in the activity information data structure to track the performance of the user in combination with the cognitive state of the user when performing the one or more activities of the activity session.

As further shown in FIG. 4B, and by reference number 425, the performance analysis system provides one or more recommendations based on the model output(s). The recommendation may indicate whether the activity decreased or increased a performance metric associated with the user performing during the activity session.

In some implementations, the performance analysis system may determine the recommendation based on whether a cognitive state of the user contributed to the performance of the activity (e.g., as determined based on the psychological impact model) and/or based on a predicted performance score (e.g., as determined based on the physiological impact model). For example, if the cognitive state (or a set of cognitive states) negatively impacted a performance of the user (relative to other performances by the user with different cognitive states), the recommendation may indicate that the user should address the user having that cognitive state prior to or during performance of a subsequent activity session that includes a same type of activity.

As shown, the performance analysis system may provide the recommendation to the user via the user device and/or a manager of the user via the manager device. The recommendation may indicate a subsequent activity type that should be performed during a subsequent activity session. Additionally, or alternatively, the recommendation may indicate a time during which a subsequent activity session should occur and/or a time period during which a subsequent performance of an activity should be performed within a subsequent activity session. In some implementations, if the performance profile indicates that the user has a negative sentiment toward an activity and/or that a user performed an activity poorly in combination with a certain set of cognitive states, the recommendation may indicate a program for altering which activities should be performed during a subsequent activity session and/or a program for altering a cognitive state of the user prior to or during a subsequent performance of the subsequent activity session.

As further shown in FIG. 4B, and by reference number 430, the performance analysis system retrains the model(s). For example, the performance analysis system may configure, as a set of training data for one or more of the performance analysis models, the cognitive state score and the performance data associated with the user performing the activity. In some implementations, the performance analysis system may retrain the performance analysis model by updating the historical data to include validated or invalidated results associated with input values of the one or more performance analysis parameters. Accordingly, the performance analysis system may retrain the performance analysis model using the set of training data, as described elsewhere herein.

As indicated above, FIGS. 4A-4B are provided as an example. Other examples may differ from what is described with regard to FIGS. 4A-4B. The number and arrangement of devices shown in FIGS. 4A-4B are provided as an example. In practice, there may be additional devices, fewer devices, different devices, or differently arranged devices than those shown in FIGS. 4A-4B. Furthermore, two or more devices shown in FIGS. 4A-4B may be implemented within a single device, or a single device shown in FIGS. 4A-4B may be implemented as multiple, distributed devices. Additionally, or alternatively, a set of devices (e.g., one or more devices) shown in FIGS. 4A-4B may perform one or more functions described as being performed by another set of devices shown in FIGS. 4A-4B.

FIG. 5 is a diagram of an example environment 500 in which systems and/or methods described herein may be implemented. As shown in FIG. 5, environment 500 may include a performance analysis system 510, a user device 520, a performance monitoring device) 530, a manager device 540, and a network 550. Devices of environment 500 may interconnect via wired connections, wireless connections, or a combination of wired and wireless connections.

The performance analysis system 510 includes one or more devices capable of receiving, generating, storing, processing, providing, and/or routing information associated with utilizing machine learning and cognitive state analysis to track a user performance, as described elsewhere herein. The performance analysis system 510 may include a communication device and/or a computing device. For example, the performance analysis system 510 may include a server, such as an application server, a client server, a web server, a database server, a host server, a proxy server, a virtual server (e.g., executing on computing hardware), or a server in a cloud computing system. In some implementations, the performance analysis system 510 includes computing hardware used in a cloud computing environment.

The user device 520 includes one or more devices capable of receiving, generating, storing, processing, and/or providing information associated with monitoring performance of an activity by a user (e.g., via an application), as described elsewhere herein. The user device 520 may include a communication device and/or a computing device. For example, the user device 520 may include a wireless communication device, a mobile phone, a user equipment, a laptop computer, a tablet computer, a desktop computer, a gaming console, or a similar type of device.

The performance monitoring device 530 includes one or more devices capable of receiving, generating, storing, processing, and/or providing information associated with measuring performance of an activity by a user, as described elsewhere herein. The performance monitoring device 530 may include a communication device and/or a computing device. For example, the performance monitoring device 530 may include a communication device (e.g., a wireless or wired communication device), a wearable communication device (e.g., a smart wristwatch, a pair of smart eyeglasses, a head mounted display, or a virtual reality headset), exercise equipment, or a similar type of device that includes a performance sensor for measuring a performance metric as described elsewhere herein.

The manager device 540 includes one or more devices capable of receiving, generating, storing, processing, and/or providing information associated with managing a performance of an activity by a user, as described elsewhere herein. The manager device 540 may include a communication device and/or a computing device. For example, the manager device 540 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 550 includes one or more wired and/or wireless networks. For example, the network 550 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 550 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600, which may correspond to the performance analysis system 510, the user device 520, the performance monitoring device 530, and/or the manager device 540. In some implementations, the performance analysis system 510, the user device 520, the performance monitoring device 530, and/or the manager device 540 may include one or more devices 600 and/or one or more components of device 600. As shown in FIG. 6, device 600 may include a bus 610, a processor 620, a memory 630, an input component 640, an output component 650, and a communication component 660.

Bus 610 includes one or more components that enable wired and/or wireless communication among the components of device 600. Bus 610 may couple together two or more components of FIG. 6, such as via operative coupling, communicative coupling, electronic coupling, and/or electric coupling. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform one or more operations or processes described elsewhere herein.

Memory 630 includes volatile and/or nonvolatile memory. For example, memory 630 may include random access memory (RAM), read only memory (ROM), a hard disk drive, and/or another type of memory (e.g., a flash memory, a magnetic memory, and/or an optical memory). Memory 630 may include internal memory (e.g., RAM, ROM, or a hard disk drive) and/or removable memory (e.g., removable via a universal serial bus connection). Memory 630 may be a non-transitory computer-readable medium. Memory 630 stores information, instructions, and/or software (e.g., one or more software applications) related to the operation of device 600. In some implementations, memory 630 includes one or more memories that are coupled to one or more processors (e.g., processor 620), such as via bus 610.

Input component 640 enables device 600 to receive input, such as user input and/or sensed input. For example, input component 640 may include a touch screen, a keyboard, a keypad, a mouse, a button, a microphone, a switch, a sensor, a global positioning system sensor, an accelerometer, a gyroscope, and/or an actuator. Output component 650 enables device 600 to provide output, such as via a display, a speaker, and/or a light-emitting diode. Communication component 660 enables device 600 to communicate with other devices via a wired connection and/or a wireless connection. For example, communication component 660 may include a receiver, a transmitter, a transceiver, a modem, a network interface card, and/or an antenna.

Device 600 may perform one or more operations or processes described herein. For example, a non-transitory computer-readable medium (e.g., memory 630) may store a set of instructions (e.g., one or more instructions or code) for execution by processor 620. Processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, processor 620 may be configured to perform one or more operations or processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

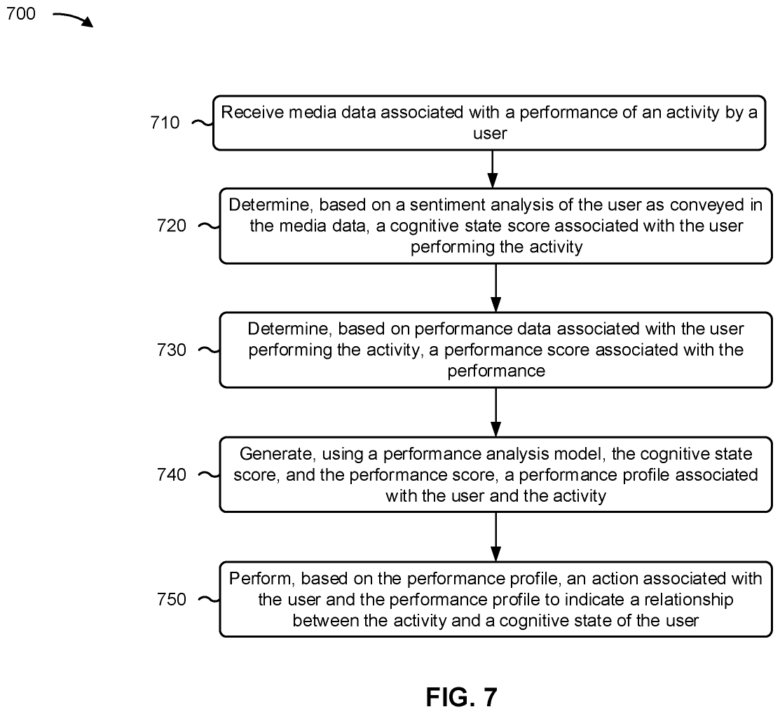

FIG. 7 is a flowchart of an example process 700 associated with utilizing machine learning and cognitive state analysis to track user performance. In some implementations, one or more process blocks of FIG. 7 may be performed by a performance analysis system (e.g., performance analysis system 510). In some implementations, one or more process blocks of FIG. 7 may be performed by another device or a group of devices separate from or including the performance analysis system, such as a user device (e.g., the user device 520), a performance monitoring device (e.g., the performance monitoring device 530), and/or a manager device (e.g., the manager device 540). Additionally, or alternatively, one or more process blocks of FIG. 7 may be performed by one or more components of device 600, such as processor 620, memory 630, input component 640, output component 650, and/or communication component 660.

As shown in FIG. 7, process 700 may include receiving media data associated with a performance of an activity by a user (block 710). For example, the performance analysis system may receive media data associated with a performance of an activity by a user, as described above.

As further shown in FIG. 7, process 700 may include determining, based on a sentiment analysis of the user as conveyed in the media data, a cognitive state score associated with the user performing the activity (block 720). For example, the performance analysis system may determine, based on a sentiment analysis of the user as conveyed in the media data, a cognitive state score associated with the user performing the activity, as described above. In some implementations, the cognitive state score is representative of a cognitive state of the user when performing the activity.

As further shown in FIG. 7, process 700 may include determining, based on performance data associated with the user performing the activity, a performance score associated with the performance (block 730). For example, the performance analysis system may determine, based on performance data associated with the user performing the activity, a performance score associated with the performance, as described above.

As further shown in FIG. 7, process 700 may include generating, using a performance analysis model, the cognitive state score, and the performance score, a performance profile associated with the user and the activity (block 740). For example, the performance analysis system may generate, using a performance analysis model, the cognitive state score, and the performance score, a performance profile associated with the user and the activity, as described above.

As further shown in FIG. 7, process 700 may include performing, based on the performance profile, an action associated with the user and the performance profile to indicate a relationship between the activity and a cognitive state of the user (block 750). For example, the performance analysis system may perform, based on the performance profile, an action associated with the user and the performance profile to indicate a relationship between the activity and a cognitive state of the user, as described above.

Process 700 may include additional implementations, such as any single implementation or any combination of implementations described below and/or in connection with one or more other processes described elsewhere herein.

In a first implementation, the cognitive state score is representative of the cognitive state of the user being based on a sentiment of the user toward the activity.

In a second implementation, alone or in combination with the first implementation, the performance analysis model comprises a machine learning model that is trained based on historical performance data and historical cognitive state scores associated with corresponding historical activities performed during historical activity sessions.

In a third implementation, alone or in combination with one or more of the first and second implementations, the corresponding historical activities were performed by the user, the historical performance data is associated with the user, and the historical cognitive state scores are associated with a sentiment of the user toward the historical activities.

In a fourth implementation, alone or in combination with one or more of the first through third implementations, process 700 includes indicating, within the performance profile, a predicted performance score associated with a subsequent performance of the activity by the user, and indicating, within the performance profile, a predicted performance metric relevance score associated with a set of cognitive states of the user subsequently performing the activity during a subsequent activity session.

In a fifth implementation, alone or in combination with one or more of the first through fourth implementations, process 700 includes configuring the cognitive state score and the performance data as a set of training data for the performance analysis model, and retraining the performance analysis model using the set of training data.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, by a device, performance data associated with a performance of a user during an activity session;
receiving, by the device and from a user device, media data associated with the user being involved in the activity session;
processing, by the device and using a cognitive state analysis model, the media data to determine a cognitive state score associated with a cognitive state of the user in relation to the activity session;
processing, by the device and using a performance analysis model, the cognitive state score and the performance data to generate a performance profile for the user,
wherein the performance analysis model comprises a machine learning model that is trained based on historical performance data and historical cognitive state scores associated with corresponding historical activities performed during historical activity sessions;
determining, by the device and based on the performance profile, a recommendation associated with an activity performed during the activity session; and
performing, by the device and based on the performance profile, an action associated with the recommendation.

2. The method of claim 1, wherein the performance data is captured by a performance sensor that is associated with a wearable device that is worn by the user,
wherein the performance data is associated with one or more physiological metrics of the user that are measured by the performance sensor during the activity session, and
wherein the performance data is received from the wearable device.

3. The method of claim 1, wherein the media data includes content that is associated with at least one of:
the user preparing to perform the activity during the activity session,
the user performing the activity during the activity session, or
the user reflecting on the performance of the activity.

4. The method of claim 1, wherein the performance analysis model is configured to generate the performance profile to indicate:
whether the cognitive state of the user as indicated by the cognitive state score contributed to the performance, by the user, as indicated by the performance data,
wherein the recommendation is determined based on whether the cognitive state contributed to the performance of the activity.

5. The method of claim 1, wherein the performance analysis model is configured to generate the performance profile to indicate:
a predicted performance score associated with a subsequent performance of the activity, by the user, during a subsequent activity session that involves the activity,
wherein the recommendation is determined based on the predicted performance score.

6. The method of claim 1, wherein the machine learning model is configured to predict a sentiment of the user toward the activity or the activity session based on at least one of:
a random-forest-based classification processing of the historical performance data and the historical cognitive state scores,
a k-fold cross validation processing based on a resampling of the historical performance data and the historical cognitive state scores, or
an optimization technique for optimizing one or more random-forest hyperparameters that are based on the historical performance data and the historical cognitive state scores.

7. The method of claim 1, wherein performing the action comprises:
providing, to the user device or another user device, the recommendation to indicate whether the activity decreased or increased a performance metric associated with the user performing during the activity session.

8. A device, comprising:
one or more memories; and
one or more processors, coupled to the one or more memories, configured to:
receive performance data associated with a performance of an activity by a user;
receive media data associated with the user being involved in the activity;
process, using a cognitive state analysis model, the media data to determine a cognitive state score associated with the user in relation to the activity,
wherein the cognitive state score is representative of a cognitive state of the user relative to the user being involved in the activity;
process, using a performance analysis model, the cognitive state score and the performance data to generate a performance profile for the user,
wherein the performance analysis model comprises a machine learning model that is trained based on historical performance data and historical cognitive state scores associated with the user performing corresponding historical activities; and
provide information from the performance profile that is associated with the user performing the activity in association with the cognitive state.

9. The device of claim 8, wherein the performance analysis model is configured to generate the performance profile to indicate at least one of:
whether the cognitive state of the user, as indicated by the cognitive state score, affected the performance, by the user, as indicated by the performance data, or
a predicted performance score associated with a subsequent performance of the activity, by the user, during a subsequent activity session that involves the activity.

10. The device of claim 8, wherein the machine learning model is configured to predict a sentiment of the user toward the activity.

11. The device of claim 8, wherein the machine learning model is configured to predict a performance metric relevance score associated with a set of cognitive states of the user subsequently performing the activity during a subsequent activity session based on at least one of:
a support vector regression involving the historical performance data and the historical cognitive state scores, or
a linear regression involving the historical performance data and the historical cognitive state scores.

12. The device of claim 11, wherein the performance metric relevance score is indicative of an impact that the set of cognitive states has on a particular performance metric.

13. The device of claim 12, wherein the particular performance metric comprises at least one of:
a physiological stress metric associated with a subsequent performance of a subsequent activity that is associated with the activity,
an activity load metric associated with a time period prior to the activity session,
an activity fatigue metric associated with fatigue of the user prior to the activity session,
a power metric associated with a strength of the user during the activity session,
an intensity score associated with a relative strength of the user based on the power metric during the activity session,
a time metric associated with timing to complete activities of the activity session, or
an exertion metric that is indicative of a degree of exertion of the user during the activity session.

14. The device of claim 8, wherein the one or more processors are further configured to:
configure the cognitive state score and the performance data as a set of training data for the performance analysis model; and
retrain the performance analysis model using the set of training data.

15. A non-transitory computer-readable medium storing a set of instructions, the set of instructions comprising:
one or more instructions that, when executed by one or more processors of a device, cause the device to:
receive media data associated with a performance of an activity by a user;
determine, based on a sentiment analysis of the user as conveyed in the media data, a cognitive state score associated with the user performing the activity,
wherein the cognitive state score is representative of a cognitive state of the user when performing the activity;
determine, based on performance data associated with the user performing the activity, a performance score associated with the performance;
generate, using a performance analysis model, the cognitive state score, and the performance score, a performance profile associated with the user and the activity; and
perform, based on the performance profile, an action associated with the user and the performance profile to indicate a relationship between the activity and a cognitive state of the user.

16. The non-transitory computer-readable medium of claim 15, wherein the cognitive state score is representative of the cognitive state being based on a sentiment of the user toward the activity.

17. The non-transitory computer-readable medium of claim 15, wherein the performance analysis model comprises a machine learning model that is trained based on historical performance data and historical cognitive state scores associated with corresponding historical activities performed during historical activity sessions.

18. The non-transitory computer-readable medium of claim 17, wherein the corresponding historical activities were performed by the user, the historical performance data is associated with the user, and the historical cognitive state scores are associated with a sentiment of the user toward the historical activities.

19. The non-transitory computer-readable medium of claim 15, wherein the one or more instructions, that cause the device to generate the performance profile, cause the device to:
indicate, within the performance profile, a predicted performance score associated with a subsequent performance of the activity by the user, and
indicate, within the performance profile, a predicted performance metric relevance score associated with a set of cognitive states of the user subsequently performing the activity during a subsequent activity session.

20. The non-transitory computer-readable medium of claim 15, wherein the one or more instructions further cause the device to:
configure the cognitive state score and the performance data as a set of training data for the performance analysis model; and
retrain the performance analysis model using the set of training data.
